(19) United States
(12) Patent Application Publication
(10) Pub. No.: US 2025/0102705 A1
(43) Pub. Date: Mar. 27, 2025

(54) METASURFACE REFLECTOR, PROJECTION DEVICE, AND NEAR-EYE WEARABLE DEVICE

(71) Applicant: TDK Corporation, Tokyo (JP)

(72) Inventors: Tomohito MIZUNO, Tokyo (JP); Hideaki FUKUZAWA, Tokyo (JP); Tetsuya SHIBATA, Tokyo (JP); Tsuyoshi KOMAKI, Tokyo (JP); Takeshi NOJIRI, Tokyo (JP)

(73) Assignee: TDK Corporation, Tokyo (JP)

(21) Appl. No.: 18/891,263

(22) Filed: Sep. 20, 2024

(30) Foreign Application Priority Data
Sep. 25, 2023 (JP) 2023-160141

(51) Int. Cl. G02B 1/00; G02B 27/01; G02B 27/18

(52) U.S. Cl. CPC G02B 1/002; G02B 27/0172; G02B 27/18; G02B 2027/0154; G02B 2027/0178; G02B 2207/101

(57) ABSTRACT

A metasurface reflector includes: a first metal layer and a second metal layer stacked in a first direction; a dielectric layer provided between the first metal layer and the second metal layer in the first direction; and a protective layer covering a surface of the second metal layer opposite to the dielectric layer. The dielectric layer includes a main surface on which the second metal layer is provided. The metasurface reflector is divided into a plurality of unit regions arranged in a second direction along the main surface and in a third direction along the main surface and intersecting the second direction. The second metal layer includes metal units respectively provided in all or some of the plurality of unit regions. The protective layer is made of a metal having a standard electrode potential higher than that of a metal constituting the second metal layer.

### CROSS-REFERENCE TO RELATED APPLICATION

This application claims the benefit of priority from Japanese Patent Application No. 2023-160141 filed with the Japan Patent Office on Sep. 25, 2023, the entire contents of which are incorporated herein by reference.

### TECHNICAL FIELD

The present disclosure relates to a metasurface reflector, a projection device, and a near-eye wearable device.

### BACKGROUND

Reflectors using metasurface technology are known. For example, US Patent Application Publication No. 2018/0113310 describes a near-eye display assembly including an image source and a combiner including a nanostructured surface optically coupled to the image source. The unit cell of the nanostructure surface is configured by stacking a base layer, a dielectric layer, and a meta atom layer in that order.

### SUMMARY

In the near-eye display assembly described in US Patent Application Publication No. 2018/0113310, the meta atom layer is exposed. When a metal layer such as silver and aluminum is used as the meta atom layer, the metal layer may be oxidized or sulfurized when exposed to air. In this case, the optical characteristics may be changed and the reflection characteristics may be deteriorated.

The present disclosure describes a metasurface reflector, a projection device, and a near-eye wearable device capable of suppressing deterioration of reflection characteristics.

A metasurface reflector according to one aspect of the present disclosure includes: a first metal layer and a second metal layer stacked in a first direction; a dielectric layer provided between the first metal layer and the second metal layer in the first direction; and a protective layer covering a surface of the second metal layer opposite to the dielectric layer. The dielectric layer includes a main surface on which the second metal layer is provided. The metasurface reflector is divided into a plurality of unit regions arranged in a second direction along the main surface and in a third direction along the main surface and intersecting the second direction. The second metal layer includes metal units respectively provided in all or some of the plurality of unit regions. The protective layer is made of a metal having a standard electrode potential higher than that of a metal constituting the second metal layer.

In the metasurface reflector, the protective layer covers the surface of the second metal layer opposite to the dielectric layer. Therefore, since the surface of the second metal layer is not exposed to air when the metasurface reflector is used, the possibility that the second metal layer is oxidized and sulfurized is reduced. Furthermore, since the protective layer is made of a metal having a standard electrode potential higher than that of a metal constituting the second metal layer, the protective layer is less likely to be oxidized and sulfurized than the second metal layer. Accordingly, in the metasurface reflector, a change in the optical characteristics hardly occurs. As a result, deterioration of the reflection characteristics can be suppressed.

A length of the protective layer in the first direction may be 20% or less of a sum of a length of the second metal layer in the first direction and the length of the protective layer in the first direction. In this case, the protective layer can be provided while suppressing the influence on the reflection characteristics of the metasurface reflector. Accordingly, deterioration of the reflection characteristics can be further suppressed.

Each of the metal units may be a metal body having a trapezoidal shape when viewed from the first direction. In this case, the structure of the metal unit can be simplified as compared with the case where the metal unit is composed of a plurality of metal bodies. Accordingly, the manufacturing of the metasurface reflector can be facilitated.

A length of the metal body in the second direction may be 500 nm or more and 2500 nm or less. A length of the metal body in the first direction may be 10 nm or more and 100 nm or less. A length of a short side of the metal body may be 10 nm or more and 200 nm or less. A length of a long side of the metal body may be larger than the length of the short side and may be 100 nm or more and 500 nm or less. In this case, the reflection efficiency for visible light can be enhanced.

The protective layer may be made of a metal containing at least one element selected from a group consisting of gold, ruthenium, and iridium. In this case, the deterioration of the reflection characteristics can be suppressed as compared with molybdenum, titanium, tungsten and the like.

The second metal layer may be made of a metal containing at least one element selected from a group consisting of silver, aluminum, and copper. In this case, the second metal layer having a relatively high reflectance and a relatively high electric conductivity can be obtained. Accordingly, the electromagnetic resonance between the first metal layer and the second metal layer can be strengthened, and the reflection efficiency can be enhanced.

The dielectric layer may be made of a material transparent in a visible light region. In this case, since the absorption rate of visible light in the dielectric layer is suppressed, the reflection efficiency for visible light can be enhanced.

The dielectric layer may be made of a compound selected from a group consisting of silicon oxide, titanium oxide, magnesium oxide, and aluminum oxide. In this case, the dielectric layer having a dielectric constant that does not interfere with the electromagnetic action can be obtained. Accordingly, the electromagnetic resonance between the first metal layer and the second metal layer can be strengthened, and the reflection efficiency can be enhanced.

A length of the dielectric layer in the first direction may be 10 nm or more and 100 nm or less. A length of the first metal layer in the first direction may be 50 nm or more and 1000 nm or less. In this case, the possibility that the dielectric layer interferes with the electromagnetic action can be reduced, and the possibility that the laser light passes through the first metal layer can be reduced. Accordingly, the reflection efficiency can be enhanced.

A projection device according to another aspect of the present disclosure is a projection device mounted on a near-eye wearable device. The projection device includes: a light source that emits laser light; a movable mirror that performs scanning with the laser light; and the above-described metasurface reflector that reflects the laser light having passed through the movable mirror to cause a user wearing the near-eye wearable device to visually recognize an image. In the projection device as well, deterioration of the reflection characteristics can be suppressed.

A near-eye wearable device according to still another aspect of the present disclosure includes: the above-described projection device; and a lens provided with the metasurface reflector. In the near-eye wearable device as well, deterioration of the reflection characteristics can be suppressed.

According to each aspect and each embodiment of the present disclosure, deterioration of the reflection characteristics can be suppressed.

### BRIEF DESCRIPTION OF THE DRAWINGS

FIG. 1 is a perspective view showing an appearance of a near-eye wearable device to which a metasurface reflector according to an embodiment is applied.

FIG. 2 is a configuration diagram schematically showing the projection device shown in FIG. 1.

FIG. 3 is an enlarged view of the metasurface reflector shown in FIG. 2.

FIG. 4 is a perspective view schematically showing the unit region shown in FIG. 3.

FIG. 5 is a cross-sectional view taken along the line V-V of FIG. 4.

FIG. 6 is a diagram for explaining the principle of reflection by the metasurface reflector shown in FIG. 2.

FIG. 7 is a diagram showing the phase change amount of reflected light at the position of the metasurface reflector in the X-axis direction.

FIG. 8 is a diagram for explaining the relationship between the position in the X-axis direction and the length of the metal unit in the X-axis direction.

FIG. 9 is a diagram showing the relationship between the proportion of the protective layer and the reflected electric field strength.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system may be shown. The Y-axis direction (third direction) is a direction intersecting (for example, orthogonal to) the X-axis direction (second direction) and the Z-axis direction (first direction). The Z-axis direction is a direction intersecting (for example, orthogonal to) the X-axis direction and the Y-axis direction. In the present specification, the numerical ranges indicated by “to” represent ranges that include the values described before and after “to” as the minimum and maximum values, respectively. The individually described upper and lower limit values can be combined arbitrarily.

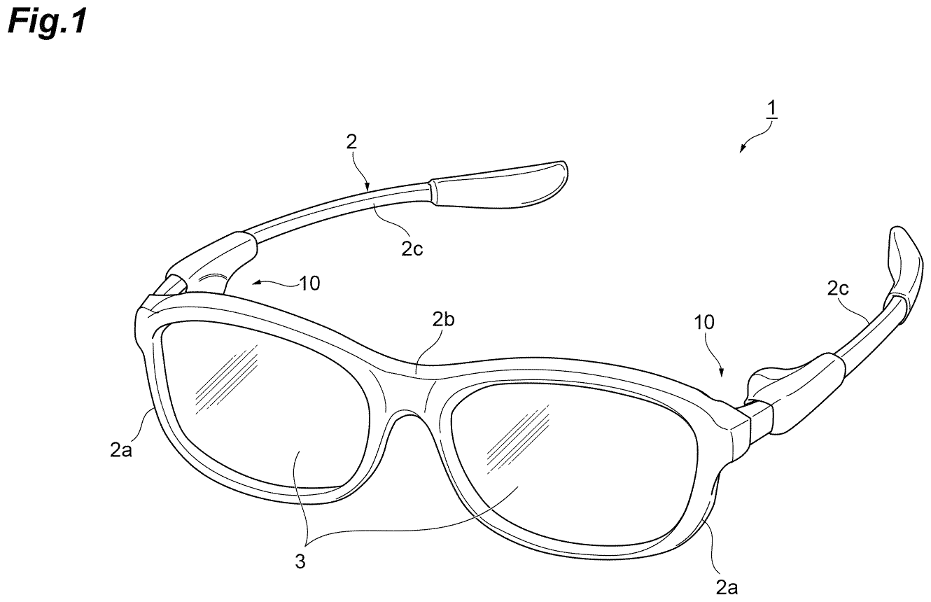

A near-eye wearable device to which a metasurface reflector according to an embodiment is applied will be described with reference to FIG. 1. FIG. 1 is a perspective view showing an appearance of a near-eye wearable device to which a metasurface reflector according to an embodiment is applied. The near-eye wearable device 1 shown in FIG. 1 is a device for superimposing an image on the field of view of the real world. The near-eye wearable device 1 is, for example, a head-mounted device, and may take the form of an eyeglass type, a goggle type, a hat type, a helmet type, or the like. Examples of the near-eye wearable device 1 include smart glasses such as augmented reality (AR) glasses, and mixed reality (MR) glasses. The near-eye wearable device 1 includes a frame 2, a lens 3, and a projection device 10.

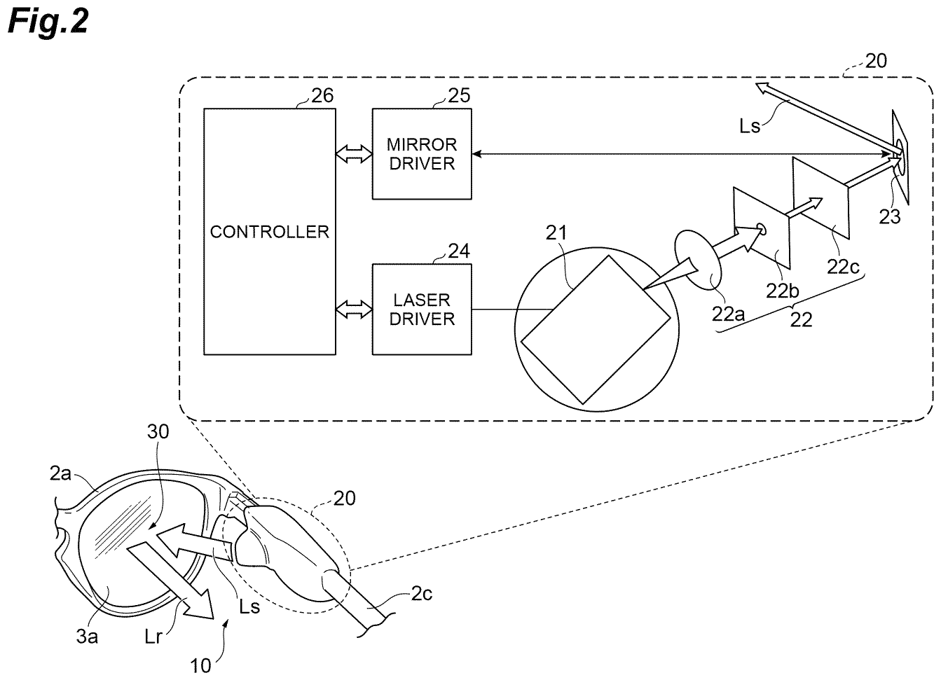

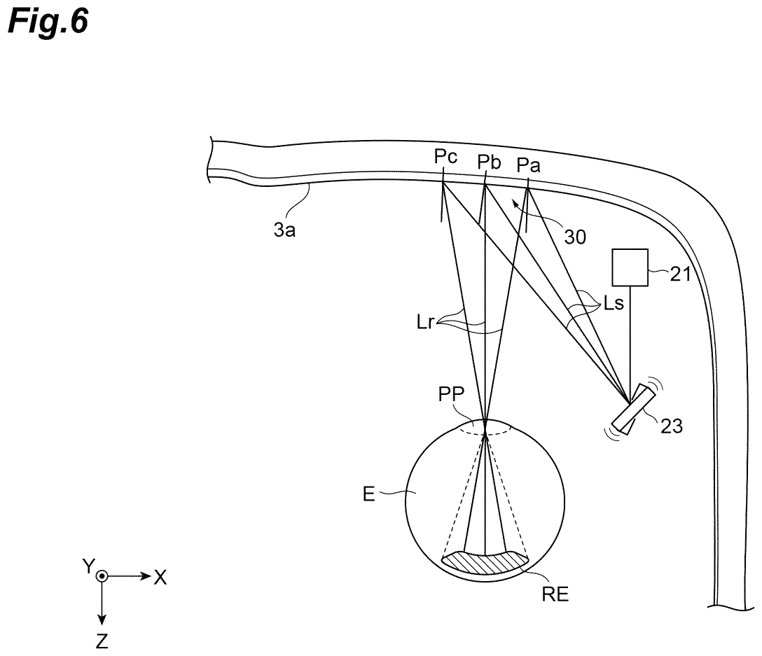

The frame 2 includes a pair of rims 2a, a bridge 2b, and a pair of temples 2c. The rim 2a is a portion for holding the lens 3. The bridge 2b is a portion connecting the pair of rims 2a. The temple 2c extends from the rim 2a and is a portion to be put on an ear of a user. The frame 2 may be a rimless frame. The lens 3 has an inner surface 3a (refer to FIG. 2) facing an eyeball E (refer to FIG. 6) of a user wearing the near-eye wearable device 1.

In the present embodiment, the projection device 10 is a device for directly projecting (drawing) an image onto a retina RE (refer to FIG. 6) of a user wearing the near-eye wearable device 1. The projection device 10 is mounted on the near-eye wearable device 1. In the present embodiment, the near-eye wearable device 1 includes two projection devices 10 in order to project an image onto both the right and left retinas RE, but may include only one of the projection devices 10.

Next, the projection device 10 will be described in detail with reference to FIG. 2. FIG. 2 is a configuration diagram schematically showing the projection device shown in FIG. 1. As shown in FIG. 2, the projection device 10 includes an optical engine 20 and a metasurface reflector 30.

The optical engine 20 is a device that generates laser light Ls having a color and intensity corresponding to a pixel of an image to be projected onto the retina RE and emits the laser light Ls to the metasurface reflector 30. The optical engine 20 is mounted on each temple 2c. The optical engine 20 includes a light source unit 21 (light source), optical components 22, a movable mirror 23, a laser driver 24, a mirror driver 25, and a controller 26.

The light source unit 21 emits laser light. As the light source unit 21, for example, a full-color laser module is used. The light source unit 21 includes a red laser diode, a green laser diode, a blue laser diode, and a multiplexer that multiplexes laser lights emitted from laser diodes into one laser light. The light source unit 21 emits the multiplexed laser light. The multiplexed laser light contains a component having a wavelength of red (red component), a component having a wavelength of green (green component), and a component having a wavelength of blue (blue component). The light source unit 21 emits laser light having a color and intensity corresponding to a pixel of an image to be projected onto the retina RE.

The optical components 22 are components that optically process the laser light emitted from the light source unit 21. In the present embodiment, the optical components 22 include a collimator lens 22a, a slit 22b, and a neutral density filter 22c. The collimator lens 22a, the slit 22b, and the neutral density filter 22c are arranged in this order along the optical path of the laser light. The optical components 22 may have other configurations.

The movable mirror 23 is an optical component for performing scanning with the laser light Ls. The movable mirror 23 is provided in a direction in which the laser light processed by the optical components 22 is emitted. The movable mirror 23 is configured to be swingable about an axis extending in the horizontal direction (X-axis direction) of the lens 3 and about an axis extending in the vertical direction (Y-axis direction) of the lens 3, for example, and reflects the laser light while changing the angle in the X-axis direction and the Y-axis direction. As the movable mirror 23, for example, a micro electro mechanical systems (MEMS) mirror is used.

The laser driver 24 is a driving circuit for driving the light source unit 21. The laser driver 24 drives the light source unit 21 based on, for example, the intensity of the laser light and the temperature of the light source unit 21. The mirror driver 25 is a driving circuit for driving the movable mirror 23. The mirror driver 25 swings the movable mirror 23 within a predetermined angle range and at a predetermined timing. The controller 26 is a device for controlling the laser driver 24 and the mirror driver 25.

In the optical engine 20, laser light having a color and intensity corresponding to a pixel of an image to be projected onto the retina RE is emitted from the light source unit 21, passes through the optical components 22, and is reflected by the movable mirror 23. The laser light reflected by the movable mirror 23 is emitted to the metasurface reflector 30 as the laser light Ls.

The metasurface reflector 30 is an optical component that reflects the laser light Ls that has passed through the movable mirror 23 to cause a user wearing the near-eye wearable device 1 to visually recognize an image. No image is displayed on the metasurface reflector 30. The metasurface reflector 30 is provided on the inner surface 3a of the lens 3.

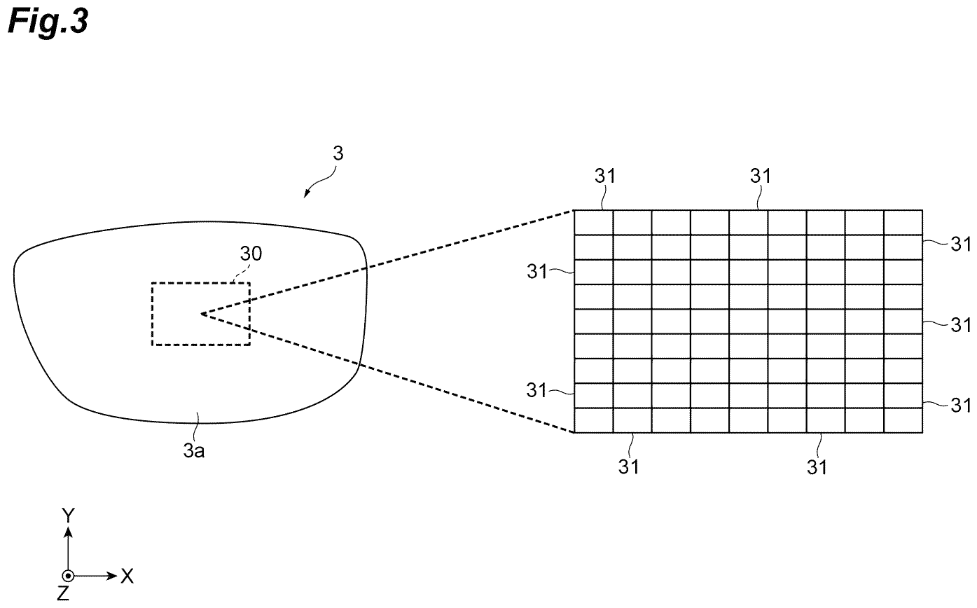

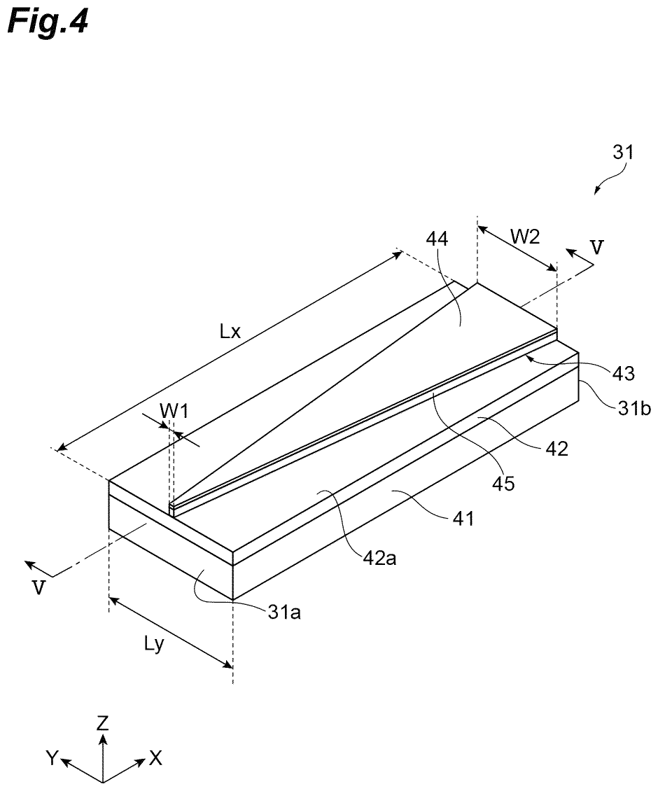

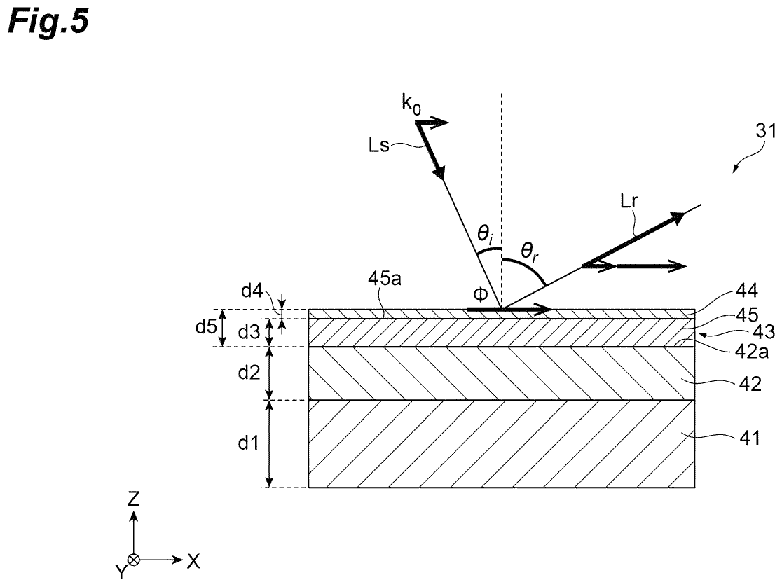

Next, the configuration of the metasurface reflector 30 will be described with reference to FIGS. 3 to 5. FIG. 3 is an enlarged view of the metasurface reflector shown in FIG. 2. FIG. 4 is a perspective view schematically showing the unit region shown in FIG. 3. FIG. 5 is a cross-sectional view taken along the line V-V of FIG. 4.

As shown in FIG. 3, the metasurface reflector 30 is divided into a plurality of unit regions 31. The plurality of unit regions 31 is provided along the inner surface 3a of the lens 3. The plurality of unit regions 31 is arranged in a two-dimensional array in the horizontal direction (X-axis direction) and the vertical direction (Y-axis direction) of the lens 3.

As shown in FIGS. 4 and 5, the metasurface reflector 30 includes a metal layer 41 (first metal layer), a dielectric layer 42, a metal layer 43 (second metal layer), and a protective layer 44 in sequence in the Z-axis direction.

The metal layer 41 is a base layer. The metal layer 41 is provided on the inner surface 3a of the lens 3. The metal layer 41 is made of a metal having high reflection characteristics in the visible light region. The metal layer 41 is made of, for example, a metal containing at least one element selected from the group consisting of gold (Au), copper (Cu), silver (Ag), and aluminum (Al). The length (thickness d1) of the metal layer 41 in the Z-axis direction may be any length as long as the metal layer 41 is capable of passing a resonance current and reflecting light. The thickness d1 is, for example, 50 nm to 1000 nm. Hereinafter, the length in the Z-axis direction may be referred to as “thickness”.

The dielectric layer 42 is a layer functioning as a spacer. The dielectric layer 42 is provided between the metal layer 41 and the metal layer 43 in the Z-axis direction. In the present embodiment, the dielectric layer 42 is provided on the metal layer 41. The dielectric layer 42 has a main surface 42a on which the metal layer 43 is provided. The dielectric layer 42 has a dielectric constant that does not interfere with the electromagnetic action of the metal layer 41 and the metal layer 43. The dielectric layer 42 is made of a material that is transparent in the visible light region. The dielectric layer 42 may be made of a material having a high dielectric constant in order to achieve high reflection characteristics. The dielectric layer 42 is made of, for example, one compound selected from the group consisting of silicon oxides (e.g., SiO₂), titanium oxides (e.g., TiO₂), magnesium oxides (e.g., MgO), and aluminum oxides (e.g., Al₂O₃). The thickness d2 of the dielectric layer 42 is, for example, 10 nm to 100 nm.

The metal layer 43 is a layer for exciting electromagnetic resonance together with the metal layer 41. The metal layer 41 and the metal layer 43 are stacked in the Z-axis direction with the dielectric layer 42 interposed therebetween. In the present embodiment, the metal layer 43 is provided on the main surface 42a of the dielectric layer 42. The metal layer 43 is made of a metal having high reflection characteristics in the visible light region. The metal layer 43 is made of a metal containing at least one element selected from the group consisting of silver (Ag), aluminum (Al), and copper (Cu), for example.

The metal layer 43 includes a plurality of metal units 45. The metal unit 45 is provided in each of the plurality of unit regions 31. Each metal unit 45 is configured such that the phase change amount φ of the reflected light Lr by the metal unit 45 changes linearly from one end 31a (first end) to the other end 31b (second end) in the X-axis direction of the unit region 31 in which the metal unit 45 is provided. Further, each metal unit 45 is configured such that the phase change amount φ of the reflected light Lr changes substantially by 360° (2π radians) from one end 31a to the other end 31b. The phase change amount φ of the reflected light Lr is an amount by which the phase of the reflected light Lr from the phase of the reflected light Lr at a certain length of the metal unit 45 in the Y-axis direction changes when the length of the metal unit 45 in the Y-axis direction is changed. Hereinafter, the length in the Y-axis direction may be referred to as “width”.

In the present embodiment, each metal unit 45 is a single metal body having a trapezoidal shape when viewed from the Z-axis direction. The thickness d3 of each metal unit 45 is, for example, 10 nm to 100 nm. The length of each metal unit 45 in the X-axis direction is equal to or slightly shorter than the length Lx of the unit region 31 in the X-axis direction. The length of each metal unit 45 in the X-axis direction is, for example, 500 nm to 2500 nm.

The length (width W1) of the short side of each metal unit 45 is set, for example, to a value close to the resolution of the exposure device used for forming the metal unit 45. The width W1 is, for example, 10 nm to 200 nm. The length (width W2) of the long side of each metal unit 45 is larger than the width W1, and is set to a length that a phase difference of substantially 360° (2π radians) can be obtained from the phase of the reflected light Lr at the width W1. The width W2 is, for example, 100 nm to 500 nm. Each metal unit 45 is formed by photolithography, for example.

The protective layer 44 is a layer for protecting the metal layer 43 (metal unit 45). The protective layer 44 is provided on the surface 45a of each metal unit 45, and covers the surface 45a. The surface 45a is a surface of the metal layer 43 opposite to the dielectric layer 42. The protective layer 44 is made of a metal which is less susceptible to oxidation and sulfurization and has higher corrosion resistance than the metal layer 43. In other words, the protective layer 44 is made of a metal having a standard electrode potential higher than that of the metal constituting the metal layer 43. The protective layer 44 is made of, for example, a metal containing at least one element selected from the group consisting of gold (Au), ruthenium (Ru), and iridium (Ir). In a combination of these metals and a metal (for example, silver) constituting the metal layer 43, the attenuation of the near-field light is small.

In the present embodiment, the protective layer 44 includes a plurality of metal bodies having the same shape as that of the metal unit 45 when viewed from the Z-axis direction. The thickness d4 of the protective layer 44 (metal body) is 20% or less of the thickness d5 which is the sum of the thickness d3 and the thickness d4. The thickness d4 is, for example, 2.5 nm to 25 nm.

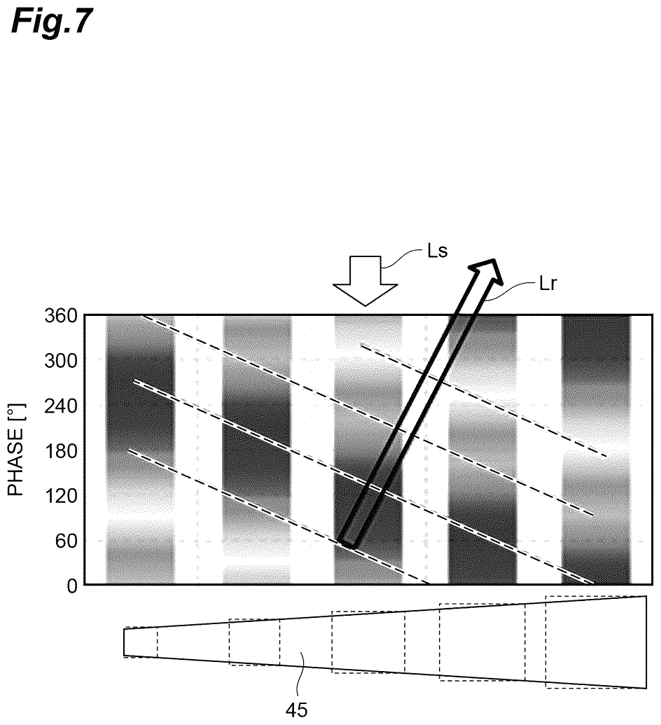

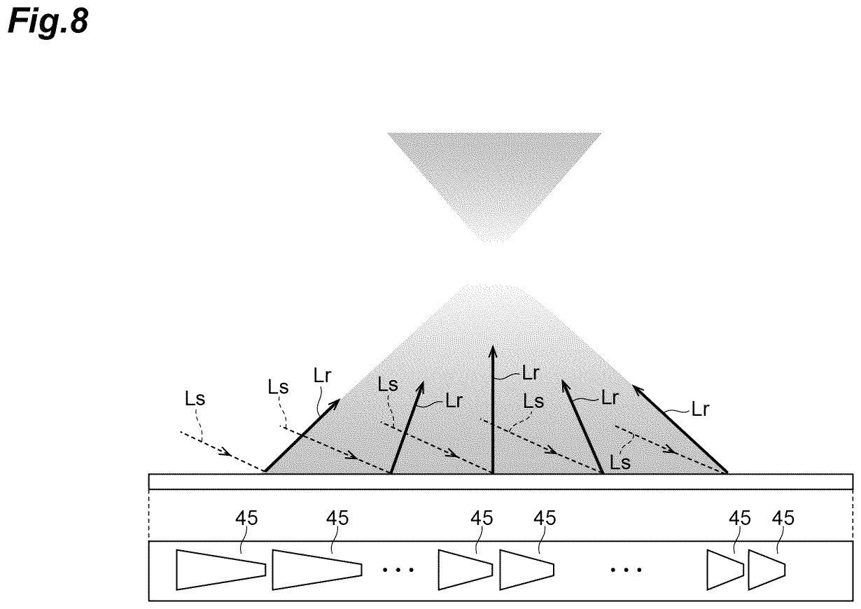

Next, a method for determining the length Lx as well as the principle of reflection by the metasurface reflector 30 will be described with reference to FIGS. 5 to 8. FIG. 6 is a diagram for explaining the principle of reflection by the metasurface reflector shown in FIG. 2. FIG. 7 is a diagram showing the phase change amount of reflected light at the position of the metasurface reflector in the X-axis direction. FIG. 8 is a diagram for explaining the relationship between the position in the X-axis direction and the length of the metal unit in the X-axis direction.

As shown in FIGS. 5 and 6, each unit region 31 is a nanostructure configured to reflect the laser light Ls at a reflection angle θᵣ corresponding to a position where the unit region 31 is provided when the laser light Ls is incident at an incident angle θᵢ corresponding to the position where the unit region 31 is provided. The reflection angle θᵣ of each unit region 31 is set so that the laser light Ls (reflected light Lr) reflected by each unit region 31 passes through the center of the pupil PP. Therefore, the incident angle θᵢ and the reflection angle θᵣ are determined by the position where the unit region 31 is provided. The unit region 31 is configured so that the incident angle θᵢ and the reflection angle θᵣ corresponding to the position where the unit region 31 is provided are obtained.

Here, the incident angle θᵢ is an angle formed by a normal line of a surface irradiated with the laser light Ls and an incident direction of the laser light Ls. The reflection angle θᵣ is an angle formed by a normal line of a surface irradiated with the laser light Ls and an emission direction of the reflected light Lr. In the plane including the laser light Ls and the reflected light Lr, when the reflected light Lr is emitted on the side opposite to the incident light (laser light Ls) with the normal line as a boundary, the reflection angle θᵣ is expressed by a positive value, and when the reflected light Lr is emitted on the same side as the incident light (laser light Ls) with the normal line as a boundary, the reflection angle θᵣ is expressed by a negative value.

For example, as shown in FIG. 6, when the pupil PP of the user faces the front, the unit regions 31 provided from the position Pa to the position Pc in the X-axis direction are used. The laser light Ls reflected by the unit region 31 provided at the position Pa corresponds to a pixel at the right end of the image. The position Pb is in the middle between the position Pa and the position Pc, and the laser light Ls reflected by the unit region 31 provided at the position Pb corresponds to a pixel in the center of the image. The laser light Ls reflected by the unit region 31 provided at the position Pc corresponds to a pixel at the left end of the image.

In the unit region 31 provided at the position Pa, the laser light Ls is incident at an incident angle θᵢ of 30°, and the laser light Ls is reflected at a reflection angle θᵣ of 5° to be emitted as the reflected light Lr. In the unit region 31 provided at the position Pb, the laser light Ls is incident at an incident angle θ; of 40°, and the laser light Ls is reflected at a reflection angle θᵣ of −5° to be emitted as the reflected light Lr. In the unit region 31 provided at the position Pc, the laser light Ls is incident at an incident angle θᵢ of 50°, and the laser light Ls is reflected at a reflection angle θᵣ of −10° to be emitted as the reflected light Lr.

As shown in FIG. 7, the width of the metal unit 45 increases from the width W1 at the one end 31a to the width W2 at the other end 31b. The phase change amount φ at each position of the metal unit 45 in the X-axis direction is substantially the same as the phase change amount φ caused by the square metal body having a side having the same length as the width at the position in the plan view. The larger the area of the square metal body in the plan view, the larger the phase change amount φ (phase delay amount) at that position. Accordingly, since the laser light Ls is reflected with different phase change amounts φ in accordance with the position in the X-axis direction, the wave front is formed by the interference between the reflected lights. That is, a plane wave having the gradient of the function φ(x) indicating the relationship between the position x in the X-axis direction and the phase change amount φ as the wave vector Φ is generated.

Here, as shown in FIG. 5, by generalizing the Snell's law, the Snell's law is expressed by Equation (1) using the wave vector k₀ of the laser light Ls, the incident angle θᵢ, the reflection angle θᵣ, and the wave vector Φ.

$$\begin{matrix}[ Equation 1 ] & \\ {k}_{0} \times sin {θ}_{i} + Φ = {k}_{0} \times sin {θ}_{r} & ( 1 )\end{matrix}$$

The wave vector k₀ is expressed by 2π/λ using the wavelength λ of the laser light Ls. The wave vector Φ is expressed by 2π/Lx using the length Lx of the unit region 31 in the X-axis direction. By transforming Equation (1) using these relations, Equation (2) is obtained.

$$\begin{matrix}[ Equation 2 ] & \\ sin {θ}_{r} = sin {θ}_{i} + \frac{λ}{L x} & ( 2 )\end{matrix}$$

The length Lx of the unit region 31 is obtained by substituting the wavelength λ of the laser light Ls and the incident angle θᵢ and the reflection angle θᵣ of the laser light Ls corresponding to the position where the unit region 31 is provided into Equation (2). The laser light Ls contains a red component, a green component, and a blue component, but the length Lx is determined using, for example, the wavelength of the green component, to which the human eyes have the highest sensitivity, as the wavelength λ.

When the length Lx is a positive value, the shape of the metal unit 45 is set to a trapezoidal shape in which the width of the metal unit 45 increases from one end 31a to the other end 31b. When the length Lx is a negative value, the shape of the metal unit 45 is set to a trapezoidal shape in which the width of the metal unit 45 decreases from one end 31a to the other end 31b.

As described above, the length Lx of each unit region 31 is determined by the wavelength λ to be reflected, and the incident angle θᵢ and the reflection angle θᵣ corresponding to the position where the unit region 31 is provided. The length of the metal unit 45 in the X-axis direction is equal to or slightly shorter than the length Lx of the unit region 31 in the X-axis direction. Accordingly, the length of the metal unit 45 in the X-axis direction is determined by the wavelength λ to be reflected, and the incident angle θᵢ and the reflection angle θᵣ corresponding to the position of the unit region 31 where the metal unit 45 is provided.

When the reflection angle θᵣ is smaller than the incident angle θᵢ, the length Lx becomes a negative value. As the difference between the incident angle θᵢ and the reflection angle θᵣ increases, the absolute value of the length Lx decreases. As shown in FIG. 8, in the near-eye wearable device 1, as the distance from the movable mirror 23 increases, the reflection angle θᵣ decreases, and the difference between the incident angle θᵢ and the reflection angle θᵣ increases, so that the length Lx also decreases. Accordingly, the lengths Lx of the unit regions 31 included in the same arrangement in the X-axis direction are different from each other, and the lengths in the X-axis direction of the metal units 45 included in the same arrangement in the X-axis direction are also different from each other.

Note that the length Ly of each unit region 31 is a predetermined fixed value. The length Ly is slightly larger than the width W2. The length Ly may be a length obtained by adding the resolution (for example, 100 nm) of the exposure device used for forming the metal unit 45 to the width W2, and is set to, for example, 600 nm. The width W1 and the width W2 of each metal unit 45 are predetermined fixed values. As described above, the width W1 is set to a value close to the resolution (for example, 100 nm) of the exposure device used for forming the metal unit 45. The width W2 is set to a length (for example, 350 nm) at which a phase difference of substantially 360° (2π radians) can be obtained from the phase of the reflected light Lr at the width W1.

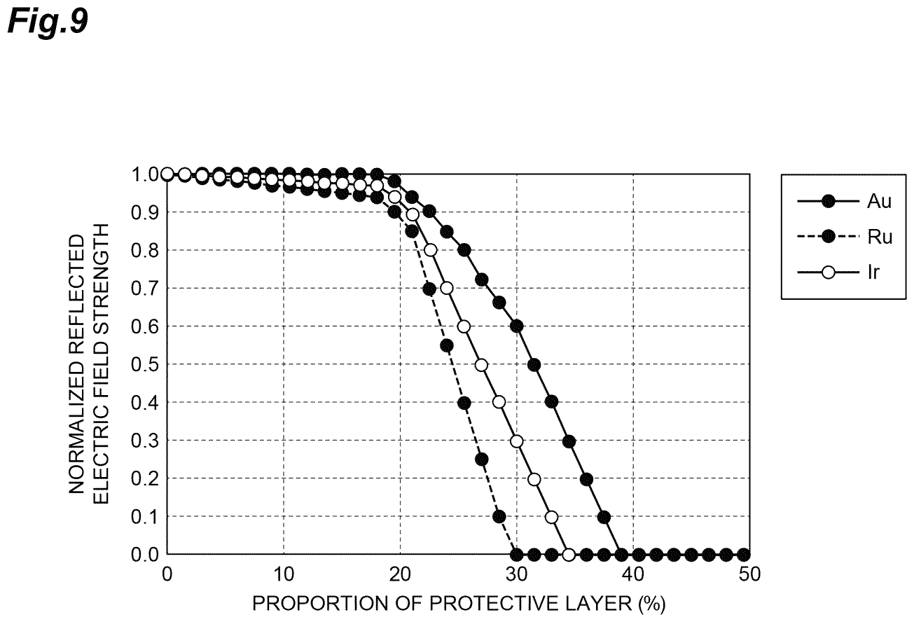

Next, the influence of the protective layer 44 on the intensity of the reflected light Lr will be described with reference to FIG. 9. FIG. 9 is a diagram showing the relationship between the proportion of the protective layer and the reflected electric field strength. The horizontal axis of FIG. 9 indicates the proportion (unit: %) of the protective layer 44. The proportion of the protective layer 44 is represented by the proportion of the thickness d4 to the thickness d5. The vertical axis of FIG. 9 indicates the reflected electric field strength normalized by setting the reflected electric field strength in the case where the protective layer 44 is not provided to 1.0.

The characteristics shown in FIG. 9 were obtained by calculation. Specifically, silver was used as a constituent material of the metal layer 41 and the metal layer 43 (metal unit 45), and SiO₂ was used as a constituent material of the dielectric layer 42. The thickness d1 was set to 200 nm, the thickness d2 was set to 40 nm, and the thickness d3 was set to 40 nm. The width W1 was set to 120 nm and the width W2 was set to 300 nm. The length of the metal unit 45 in the X-axis direction was set to 2250 nm. Then, gold, ruthenium, and iridium were used as the constituent materials of the protective layer 44, the thickness of the protective layer 44 was changed for each constituent material, and the reflected electric field strength at each thickness was calculated.

As shown in FIG. 9, it can be seen that the reflected electric field strength decreases as the proportion of the protective layer 44 increases for any of the constituent materials. When the proportion of the protective layer 44 is 20% or less, the reflected electric field strength hardly decreases from the reflected electric field strength in the case where the protective layer 44 is not provided, and the reflected electric field strength is maintained at 90% or more. On the other hand, when the proportion of the protective layer 44 exceeds 20%, the reflected electric field strength sharply decreases, and when the proportion of the protective layer 44 is about 30% to 40% or more, the reflected electric field strength becomes almost zero. From the above, it can be said that as long as the proportion of the protective layer 44 is 20% or less, the intensity of the reflected light Lr can be maintained.

Next, a method of manufacturing the near-eye wearable device 1 will be described. First, the lens 3 is prepared and set in a vacuum film deposition device. Then, the metal layer 41 is formed in a desired area on the inner surface 3a of the lens 3. Specifically, the metal layer 41 is formed by vacuum film deposition using a technique such as a direct current (DC) sputtering. For forming the metal layer 41, a metal material composed of any metal selected from a group consisting of gold (Au), copper (Cu), silver (Ag), and aluminum (Al) or a metal alloy containing at least one element selected from the above-described group is used.

Subsequently, the dielectric layer 42 is formed on the metal layer 41. Specifically, the dielectric layer 42 is formed by vacuum film deposition using a technique such as a radio frequency (RF) sputtering. For forming the dielectric layer 42, a dielectric material such as silicon dioxide (SiO₂), titanium oxide (TiO₂), magnesium oxide (MgO) or aluminum oxide (Al₂O₃) which can be formed by a semiconductor process is used.

Subsequently, a metal layer which is a base of the metal layer 43 is formed on the dielectric layer 42. Since the method of forming the metal layer which is a base of the metal layer 43 is the same as that of the metal layer 41, a detailed description thereof will be omitted. For forming the metal layer which is a base of the metal layer 43, a metal material made of any metal selected from the group consisting of copper (Cu), silver (Ag), and aluminum (Al) or a metal alloy containing at least one element selected from the group is used.

Subsequently, a metal layer (hereinafter, sometimes referred to as an “outermost metal layer”) which is a base of the protective layer 44 is formed on the metal layer which is a base of the metal layer 43. Since the method of forming the outermost metal layer is the same as that of the metal layer 41, a detailed description thereof will be omitted. For forming the outermost metal layer, a metal material made of any metal selected from the group consisting of gold (Au), ruthenium (Ru), and iridium (Ir), or a metal alloy containing at least one element selected from the group.

Subsequently, the metal layer 43 (the plurality of metal units 45) and the protective layer 44 are formed by a photolithography process and an etching process. Specifically, a liquid resist is applied onto the outermost metal layer using a spin coater or the like, and the applied liquid resist is dried to form a resist film (photoresist). Then, a pattern corresponding to the metal units 45 is transferred onto the resist film using an exposure device such as a KrF exposure device and an electron beam lithography device.

Then, the pattern transferred to the resist film is developed using a developing machine. Then, portions of the metal layer which is a base of the metal layer 43 and the outermost metal layer not covered with the pattern are removed by ion milling, and then the resist film is removed with an organic solvent (NMP). Thus, the metal layer 43 and the protective layer 44 are formed. As described above, the metasurface reflector 30 is formed on the inner surface 3a of the lens 3.

Subsequently, the frame 2 on which the optical engine 20 is mounted is prepared, and the lens 3 on which the metasurface reflector 30 is formed is mounted on the rim 2a of the frame 2. As described above, the near-eye wearable device 1 is manufactured.

The metasurface reflector 30 is not required to be directly formed on the inner surface 3a of the lens 3. For example, the metasurface reflector 30 may be formed on a base material such as a sapphire substrate or a flexible sheet. The method of forming the metasurface reflector 30 on the base material is the same as the method of forming the metasurface reflector 30 on the lens 3. In this case, a plurality of metasurface reflectors 30 may be formed on the base material. Then, by cutting the base material, a portion including one metasurface reflector 30 is obtained. The metasurface reflector 30 is formed on the inner surface 3a of the lens 3 by attaching the portion of the base material to a predetermined area of the inner surface 3a of the lens 3.

In the near-eye wearable device 1, the projection device 10, and the metasurface reflector 30 described above, the metasurface reflector 30 is divided into the plurality of unit regions 31 arranged in the X-axis direction along the main surface 42a and in the Y-axis direction along the main surface 42a and intersecting (orthogonal to) the X-axis direction, the metal unit 45 is provided in each unit region 31, and the protective layer 44 covers the surface 45a of the metal unit 45. Accordingly, since the surface 45a of the metal unit 45 is not exposed to the air when the near-eye wearable device 1, the projection device 10, and the metasurface reflector 30 are used, the possibility that the metal unit 45 is oxidized and sulfurized is reduced. Further, since the protective layer 44 is made of a metal having a standard electrode potential higher than that of the metal constituting the metal layer 43, the protective layer 44 is less likely to be oxidized and sulfurized than the metal layer 43. Accordingly, in the near-eye wearable device 1, the projection device 10, and the metasurface reflector 30, the optical characteristics hardly change. As a result, deterioration of the reflection characteristics can be suppressed.

As described above, in the manufacturing process of the metasurface reflector 30, the resist film is removed with an organic solvent (NMP). At this time, if the metal layer 43 (metal unit 45) is exposed, the metal layer 43 may be corroded by the organic solvent. On the other hand, in the near-eye wearable device 1, the projection device 10, and the metasurface reflector 30, the protective layer 44 covers the surface 45a of the metal unit 45. Since the protective layer 44 is made of a metal having a standard electrode potential higher than that of the metal constituting the metal layer 43, the protective layer 44 is less susceptible to corrosion than the metal layer 43. Accordingly, in the manufacturing process of the metasurface reflector 30, the possibility that the metal layer 43 is corroded can be reduced, and the corrosion resistance can be improved.

As the ratio of the thickness d4 to the thickness d5 increases, the influence of the protective layer 44 on the reflection characteristics of the metasurface reflector 30 increases. For example, gold (Au) reflects red light but easily absorbs green light and blue light. Ruthenium and iridium easily absorb light in the visible light region. Accordingly, if the ratio of the thickness d4 to the thickness d5 is high, the reflection characteristics of the metasurface reflector 30 may be deteriorated. On the other hand, in the metasurface reflector 30, the thickness d4 is 20% or less of the thickness d5. Therefore, the protective layer 44 can be provided while suppressing the influence of the protective layer 44 on the reflection characteristics of the metasurface reflector 30. Accordingly, deterioration of the reflection characteristics can be further suppressed.

Metals such as molybdenum, titanium, and tungsten also have high resistance to oxidation and sulfidation and exhibit high corrosion resistance, but have large absorption coefficients in the visible light region. Accordingly, if the protective layer 44 is made of any of these metals, the reflection characteristics of the metasurface reflector 30 may be deteriorated. The absorption coefficients of gold, ruthenium, and iridium in the visible light region are smaller than the absorption coefficients of metals such as molybdenum, titanium, and tungsten in the visible light region. Accordingly, when the protective layer 44 is made of a metal containing at least one element selected from the group consisting of gold, ruthenium, and iridium, the deterioration of the reflection characteristics of the metasurface reflector 30 can be further suppressed.

The metal unit 45 is a metal body having a trapezoidal shape when viewed from the Z-axis direction. Therefore, the structure of the metal unit 45 can be simplified as compared with the case where the metal unit is composed of a plurality of metal bodies. Accordingly, the manufacturing of the metasurface reflector 30 can be facilitated.

When the length of the metal unit 45 in the X-axis direction is 500 nm or more and 2500 nm or less, the reflected light Lr corresponding to a viewing angle of 40° to 60° can be obtained. When the thickness d3 is 10 nm or more and 100 nm or less, the electromagnetic resonance with the metal layer 41 through the dielectric layer 42 is effectively generated, and the reflected light Lr having a strong electric field strength can be obtained. When the width W1 is 10 nm or more and 200 nm or less and the width W2 is 100 nm or more and 500 nm or less, the phase difference between the phase of the reflected light Lr at the width W1 and the phase of the reflected light Lr at the width W2 can be set to 360° (2π radians) for the laser light Ls of the visible light. As described above, by setting the respective dimensions of the metal unit 45 within the above-described ranges, the reflection efficiency for visible light can be enhanced.

The metal layer 43 is made of a metal containing at least one element selected from the group consisting of silver, aluminum, and copper. Therefore, the metal layer 43 having a relatively high reflectance in the visible light region and a relatively high electric conductivity is obtained. Accordingly, the electromagnetic resonance between the metal layer 41 and the metal layer 43 can be strengthened, and the reflection efficiency can be enhanced.

The dielectric layer 42 is made of a material transparent in the visible light region. Accordingly, the absorption rate of visible light in the dielectric layer 42 is suppressed, so that the reflection efficiency for visible light can be enhanced.

The dielectric layer 42 is made of, for example, one compound selected from the group consisting of silicon oxide, titanium oxide, magnesium oxide, and aluminum oxide. In this case, the dielectric layer 42 having a dielectric constant that does not interfere with the electromagnetic action is obtained. Accordingly, the electromagnetic resonance between the metal layer 41 and the metal layer 43 can be strengthened, and the reflection efficiency can be enhanced.

The thickness d1 is, for example, 50 nm or more and 1000 nm or less. The thickness d2 is, for example, 10 nm or more and 100 nm or less. In this case, the possibility that the dielectric layer 42 interferes with the electromagnetic action can be reduced, and the possibility that the laser light Ls passes through the metal layer 41 can be reduced. Accordingly, the reflection efficiency can be enhanced.

The metasurface reflector, the projection device, and the near-eye wearable device according to the present disclosure are not limited to the above-described embodiments.

The near-eye wearable device 1 may be virtual reality (VR) glasses.

In the above-described embodiments, the projection device 10 directly projects (draws) an image onto the retina RE of the user of the near-eye wearable device 1. The projection device 10 may project an image onto the metasurface reflector 30.

The metasurface reflector 30 may be applied to devices other than the projection device 10. For example, the metasurface reflector 30 may be applied to a general image projection surface such as an image screen.

The plurality of unit regions 31 may include a unit region 31 for a red component, a unit region 31 for a green component, and a unit region 31 for a blue component. In the X-axis direction, the unit region 31 for the red component, the unit region 31 for the green component, and the unit region 31 for the blue component may be repeatedly arranged in that order. In the Y-axis direction as well, the unit regions 31 for the red component, the unit regions 31 for the green component, and the unit regions 31 for the blue component may be repeatedly arranged in that order.

In the above embodiments, the metal unit 45 is provided in each of all the unit regions 31 among the plurality of unit regions 31, but the metal unit 45 may be provided in each of some of the unit regions 31 among the plurality of unit regions 31.

The method for determining the length Lx is not limited to the method described in the above-described embodiments. For example, the lengths Lx of the unit regions 31 located at both ends of the metasurface reflector 30 in the X-axis direction may be determined by the above-described method, and the lengths Lx of the unit regions 31 located therebetween may be determined so as to gradually change from the length Lx of the unit region 31 located at one end of the metasurface reflector 30 in the X-axis direction to the length Lx of the unit region 31 located at the other end thereof.

The metal unit 45 is not limited to one metal body having a trapezoidal shape, and may be composed of, for example, a plurality of metal bodies arranged in the X-axis direction.

### (Additional Statements)

### [Clause 1]

A metasurface reflector comprising:
a first metal layer and a second metal layer stacked in a first direction;
a dielectric layer provided between the first metal layer and the second metal layer in the first direction; and
a protective layer covering a surface of the second metal layer opposite to the dielectric layer,
wherein the dielectric layer includes a main surface on which the second metal layer is provided,
wherein the metasurface reflector is divided into a plurality of unit regions arranged in a second direction along the main surface and in a third direction along the main surface and intersecting the second direction,
wherein the second metal layer includes metal units respectively provided in all or some of the plurality of unit regions, and
wherein the protective layer is made of a metal having a standard electrode potential higher than that of a metal constituting the second metal layer.

### [Clause 2]

The metasurface reflector according to clause 1,
wherein a length of the protective layer in the first direction is 20% or less of a sum of a length of the second metal layer in the first direction and the length of the protective layer in the first direction.

### [Clause 3]

The metasurface reflector according to clause 1 or 2,
wherein each of the metal units is a metal body having a trapezoidal shape when viewed from the first direction.

### [Clause 4]

The metasurface reflector according to clause 3,
wherein a length of the metal body in the second direction is 500 nm or more and 2500 nm or less,
wherein a length of the metal body in the first direction is 10 nm or more and 100 nm or less,
wherein a length of a short side of the metal body is 10 nm or more and 200 nm or less, and
wherein a length of a long side of the metal body is larger than the length of the short side and is 100 nm or more and 500 nm or less.

### [Clause 5]

The metasurface reflector according to any one of clauses 1 to 4,
wherein the protective layer is made of a metal containing at least one element selected from a group consisting of gold, ruthenium, and iridium.

### [Clause 6]

The metasurface reflector according to any one of clauses 1 to 5,
wherein the second metal layer is made of a metal containing at least one element selected from a group consisting of silver, aluminum, and copper.

### [Clause 7]

The metasurface reflector according to any one of clauses 1 to 6,
wherein the dielectric layer is made of a material transparent in a visible light region.

### [Clause 8]

The metasurface reflector according to clause 7,
wherein the dielectric layer is made of a compound selected from a group consisting of silicon oxide, titanium oxide, magnesium oxide, and aluminum oxide.

### [Clause 9]

The metasurface reflector according to any one of clauses 1 to 8,
wherein a length of the dielectric layer in the first direction is 10 nm or more and 100 nm or less, and
wherein a length of the first metal layer in the first direction is 50 nm or more and 1000 nm or less.

### [Clause 10]

A projection device mounted on a near-eye wearable device, the projection device comprising:
a light source configured to emit laser light;
a movable mirror configured to perform scanning with the laser light; and
the metasurface reflector according to any one of clauses 1 to 9, the metasurface reflector configured to reflect the laser light that has passed through the movable mirror to cause a user wearing the near-eye wearable device to visually recognize an image.

### [Clause 11]

A near-eye wearable device comprising:
the projection device according to clause 10; and
a lens provided with the metasurface reflector.

What is claimed is:

1. A metasurface reflector comprising:
a first metal layer and a second metal layer stacked in a first direction;
a dielectric layer provided between the first metal layer and the second metal layer in the first direction; and
a protective layer covering a surface of the second metal layer opposite to the dielectric layer,
wherein the dielectric layer includes a main surface on which the second metal layer is provided,
wherein the metasurface reflector is divided into a plurality of unit regions arranged in a second direction along the main surface and in a third direction along the main surface and intersecting the second direction,
wherein the second metal layer includes metal units respectively provided in all or some of the plurality of unit regions, and
wherein the protective layer is made of a metal having a standard electrode potential higher than that of a metal constituting the second metal layer.

2. The metasurface reflector according to claim 1,
wherein a length of the protective layer in the first direction is 20% or less of a sum of a length of the second metal layer in the first direction and the length of the protective layer in the first direction.

3. The metasurface reflector according to claim 1,
wherein each of the metal units is a metal body having a trapezoidal shape when viewed from the first direction.

4. The metasurface reflector according to claim 3,
wherein a length of the metal body in the second direction is 500 nm or more and 2500 nm or less,
wherein a length of the metal body in the first direction is 10 nm or more and 100 nm or less,
wherein a length of a short side of the metal body is 10 nm or more and 200 nm or less, and
wherein a length of a long side of the metal body is larger than the length of the short side and is 100 nm or more and 500 nm or less.

5. The metasurface reflector according to claim 1,
wherein the protective layer is made of a metal containing at least one element selected from a group consisting of gold, ruthenium, and iridium.

6. The metasurface reflector according to claim 1,
wherein the second metal layer is made of a metal containing at least one element selected from a group consisting of silver, aluminum, and copper.

7. The metasurface reflector according to claim 1,
wherein the dielectric layer is made of a material transparent in a visible light region.

8. The metasurface reflector according to claim 7,
wherein the dielectric layer is made of a compound selected from a group consisting of silicon oxide, titanium oxide, magnesium oxide, and aluminum oxide.

9. The metasurface reflector according to claim 1,
wherein a length of the dielectric layer in the first direction is 10 nm or more and 100 nm or less, and
wherein a length of the first metal layer in the first direction is 50 nm or more and 1000 nm or less.

10. A projection device mounted on a near-eye wearable device, the projection device comprising:
a light source configured to emit laser light;
a movable mirror configured to perform scanning with the laser light; and
the metasurface reflector according to claim 1, the metasurface reflector configured to reflect the laser light that has passed through the movable mirror to cause a user wearing the near-eye wearable device to visually recognize an image.

11. A near-eye wearable device comprising:
the projection device according to claim 10; and
a lens provided with the metasurface reflector.
